(19) United States
(12) Patent Application Publication
(10) Pub. No.: US 2008/0182447 A1
(43) Pub. Date: Jul. 31, 2008

(54) CONNECTOR ASSEMBLY WITH A SLIDER

(75) Inventors: Harald Michael LUTSCH, Ottrau (DE); Josip Jelak, Krizevci (HR); Boris Fretze, Zagreb (HR); Mario Hanzek, Marusevec (HR)

Correspondence Address: SUGHRUE MION, PLLC, 2100 PENNSYLVANIA AVENUE, N.W., SUITE 800, WASHINGTON, DC, 20037, US

(73) Assignee: Yazaki Europe Ltd., Hertfordshire (GB)

(21) Appl. No.: 12/019,791

(22) Filed: Jan. 25, 2008

(30) Foreign Application Priority Data
Jan. 29, 2007 (DE) 102007005198.2

(51) Int. Cl. H01R 4/50

(52) U.S. Cl. 439/347

(57) ABSTRACT

Connector assembly comprising
a first connector 1, which
   has a first housing 4 with a first end 5 and a second end 6, wherein the first housing 4 has first accommodation chambers 7 for first contact elements 8 and two second accommodation chambers 11 each for a second contact element 12 and wherein the first housing 4 has first locking means 15,
   has a slider 22, which
   is linearly displaceable in a limited manner on the first housing 4 in a direction away from the first end 5 towards the second end 6 and reversely between a first position and a second position,
   has, respectively, one receptacle 23 for one of the two second counter contact elements 26, wherein the two second counter contact elements 26 are electrically conductively connected to each other,
a second connector 2, which
   has a second housing 34 with third accommodation chambers 40 arranged correspondingly to the first accommodation chambers 7 for the first counter contact elements 36 fitting to the first contact elements 8,
   has second locking means 41, which in the connected condition of the first connector 1 with the second connector 2 are engaged with the first locking means 15,
      wherein the slider 22 has retaining means 28, which are supported on the first locking means 15, as long as the first connector 1 and the second connector 2 are not connected and, thus, the first locking means 15 and the second locking means 41 are not engaged, and retain the slider 22 in the first position and release the same, when the first locking means 15 are engaged with the second locking means 41, so that the slider 22 is transferable into the second position, in which the second contact elements 12 are connected with the second counter contact elements 26.

The invention relates to a connector assembly with a first connector and a second connector, which, respectively, accommodate first contact elements or first counter contact elements, which will be connected to each, when the two connectors are connected to each other. A linearly displaceable slider is additionally arranged to the first connector, movable into a position, characterising the completely connected connection condition, after the two connectors have taken-up a completely connected connection position relative to each and which closes a signal circuit, via which the reaching of the position is indicated.

DE 10 2004 057 093 B3 discloses a connector assembly with a first connector, having a first housing with a first end and a second end. The first housing comprises first accommodation chambers for first contact elements and second accommodation chambers for respectively a second contact element, which are arranged to a slider. The slider is direction-wise linearly displaceable on the first housing away from the first end and towards the second end and reversely in a limited manner between a first position and a second position. A second connector is provided, which can be connected to the first connector and comprises a second housing, in which third accommodation chambers, which are arranged correspondingly to the first accommodation chambers, are provided. In these third accommodation chambers, first counter contact elements, which fit to the first contact elements, are accommodated.

Furthermore, the second housing has, separated from the area, in which the third accommodation chambers for the first counter contact elements are arranged, accommodation chambers, in which second counter contact elements are provided, which are formed correspondingly to the second contact elements, arranged to the slider. The second contact elements as well as the second counter contact elements are, respectively, connected to signal lines. When connecting the two connectors, locking means on the first housing of the first connector are engaged with second locking means on the second housing of the second connector. Thus, the slider is released and the second contact elements of the slider can, then, be electrically conductively connected to the second counter contact elements on the second connector, whereby the signal circuit is closed. By means of a corresponding control, the connection condition can be indicated or used such, that the main circuits for the wires connected with the first contact elements and the first counter contact elements, will be closed.

The disadvantage of this embodiment is, that as well contact elements on the slider, which belong to the signal circuit, have to be arranged to the first connector as well as in addition the counter contact elements for the signal circuit have to be provided on the second connector. This means that in many cases interfaces provided on devices and equipment, for example of a motor vehicle, in form of second connectors cannot be used, as these have not such connection possibilities for counter contact elements.

Therefore, the object of the present invention is, to provide a connector assembly, in which the second connector only has to have the contact elements and connection possibilities, which are necessary for the main circuits and furthermore, only has the locking means, which interact with the corresponding locking means on the first connector and retain the first connector on the second connector in the connected condition.

This object is solved according to the invention by a connector assembly comprising
a first connector, which
   has a first housing with a first end and a second end, wherein the first housing has first accommodation chambers for first contact elements and two second accommodation chambers each for a second contact element and wherein the first housing has first locking means,
   has a slider, which
   is linearly displaceable in a limited manner on the first housing in a direction away from the first end towards the second end and reversely between a first position and a second position,
   has, respectively, one receptacle for one of the two second counter contact elements, wherein the two second counter contact elements are electrically conductively connected to each other,
a second connector, which
   has a second housing with third accommodation chambers arranged correspondingly to the first accommodation chambers for the first counter contact elements (36) fitting to the first contact elements,
   has second locking means, which in the connected condition of the first connector with the second connector are engaged with the first locking means,
      wherein the slider has retaining means, which are supported on the first locking means, as long as the first connector and the second connector are not connected and, thus, the first locking means and the second locking means are not engaged, and retain the slider in the first position and release the same, when the first locking means are engaged with the second locking means, so that the slider is transferable into the second position, in which the second contact elements are connected with the second counter contact elements.

Of advantage in this embodiment is, that all means, which are necessary to be able to close the signal circuit, when the two connectors are connected to each other, have only to be arranged to one connector, namely the first connector, which is provided usually on a wire harness. It is advantageous, that, for example, standard interfaces do not have to be changed, i.e. the connectors, which usually are connected to a device or equipment of a motor vehicle. This means, that even with identical formation of such second connectors, first connectors formed differently according to the requirements can be arranged to these, for example such, which only necessitate one locking with the second connector or such, when they are arranged in a hidden position can be checked from the distance, concerning their connection condition, or carry high currents, which can be additionally provided with means, which only enable an activation, when the connectors are connected, as they are provided according to the invention. These are represented by the slider with the means, with which the control circuit is closed. This achieves an increased safety for all connection assemblies, in which because of safety reasons or other reasons it is necessary, to initially carry out the connection of the first contact elements with the counter contact elements and off-set in time to connect the second contact elements with the second counter contact elements, which are arranged to the control circuit. The retainment means on the slider serve in connection with the first locking means on the first connector to allow a transfer of the slider into a position which closes the control circuit, only, when the first locking means are locked to the second locking means, i.e. are engaged or brought into engagement, whereby it is indicated, that the two connectors have taken up their final connection position. Only then the slider is released and can be moved into its second position.

Preferably, the second locking means on the second connector are represented by a projection on the second housing. The projection has a second locking face and a contact face. Preferably it is provided, that the first locking means are represented by an elastically deformable first locking arm, which extends in a direction away from the first end towards the second end and which in the direction towards the first end is integrally connected with the first housing and forms in the direction towards the second end a free end, on which the first engagement means are provided, which engage behind the projection on the second housing, representing the second locking means, in the connected condition. In this case the first locking arm has preferably two parallel arm portions, which at the free end are connected to each other by means of a cross-bar. This forms the first engagement means, wherein the first engagement means also comprise a first locking face, which is arranged on the cross-bar. This first locking face gets behind the second locking face of the projection, so that the locking arm is retained and, thus, the first housing is retained relative to the second housing.

Advantageous is, when the retaining means are represented by an elastically deformable second locking arm which is attached integrally on the slider and has a support face, which is part of a projection, and by which the second locking arm is supported on the first locking face, as long as the cross-bar of the first locking arm has not moved passed the projection on the second housing. Preferably, the second locking arm is arranged between the two parallel arm portions of the first locking arm.

In an embodiment it is provided, that the projection, when moving the slider from the first position into the second position, reaches the contact face of the projection, so that the second locking arm is deflected and the projection is moved over the projection into a position engaging behind the cross-bar. Furthermore, the slider is retained in its second position by the projection. Furthermore, the second locking arm also serves to retain the first locking arm in the engagement position relative to the projection.

Advantageous is, when the second accommodation chambers of the first housing are arranged separate from the first accommodation chambers in two parallel lugs, which are formed integrally with the first housing and extend from this from a connected end direction-wise towards the first end, and when the receptacles provided on the slider are part of tubular portions, with which they are guided on the lug. Additionally thereto, the first housing and the slider can have guide means, on which the slider is linearly displaceably guided.

Preferably the first connector serves for connecting to a wire harness, while the second connector is arranged to a device or equipment to be attached and electrically driven and which will be connected via the wire harness.

A preferred application for connector assemblies according to the invention are motor vehicles.

A preferred embodiment of the invention is shown schematically in the drawing.

It shows

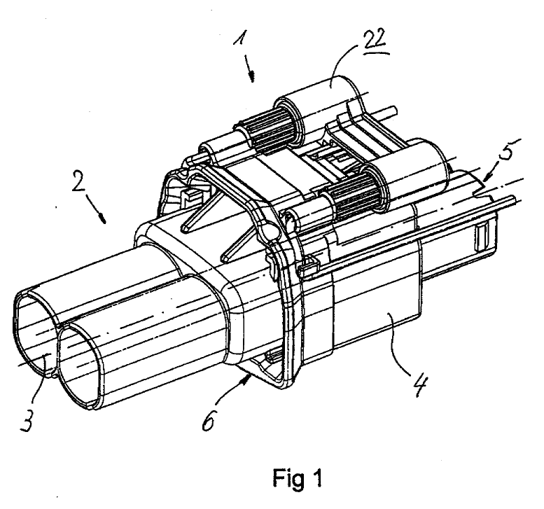

FIG. 1 the two connectors in the connected condition aligned on an axis, wherein the slider is arranged on the first connector in a first position,

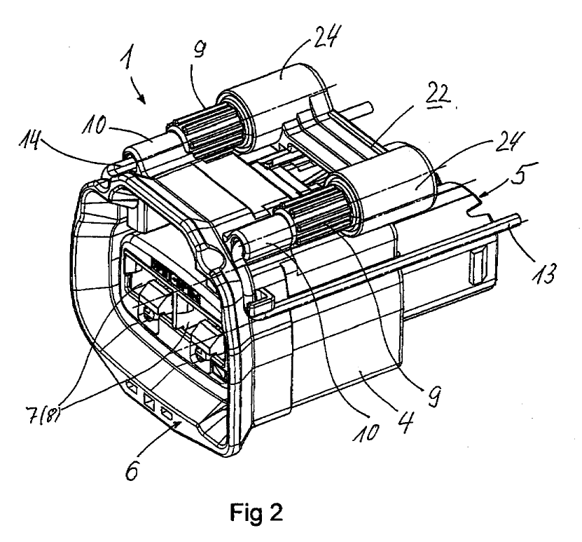

FIG. 2 a perspective representation of only the first connector,

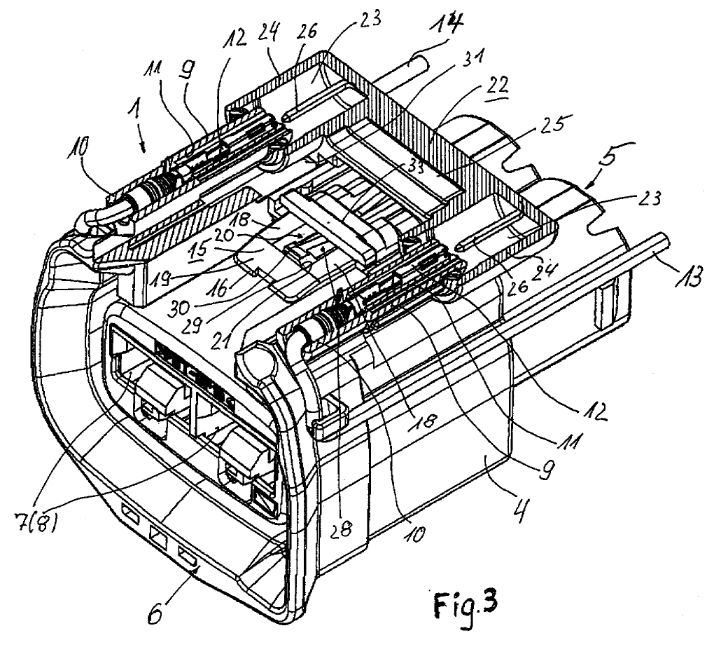

FIG. 3 a sectional view, which enables a view onto the first locking means on the first connector housing,

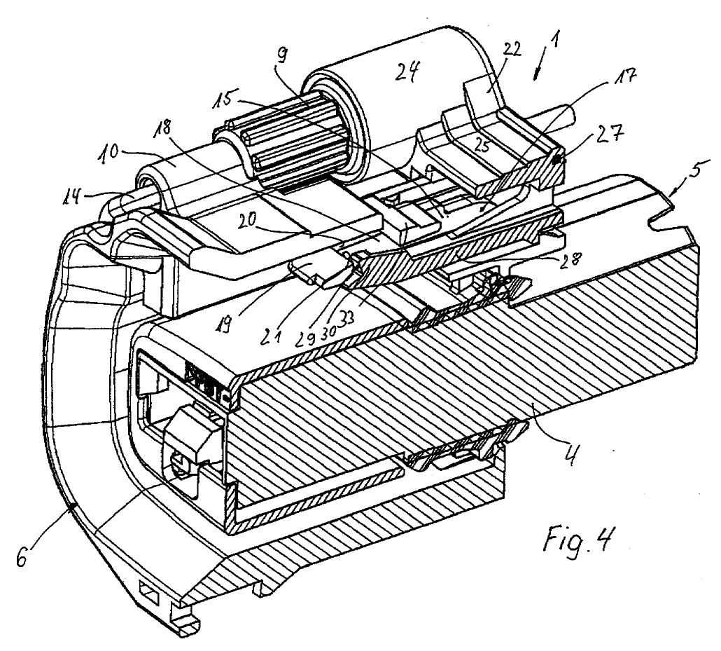

FIG. 4 a longitudinal sectional view through the first connector, which enables a view onto the mutual support of the second locking arm of the slider in its first position on the first locking arm,

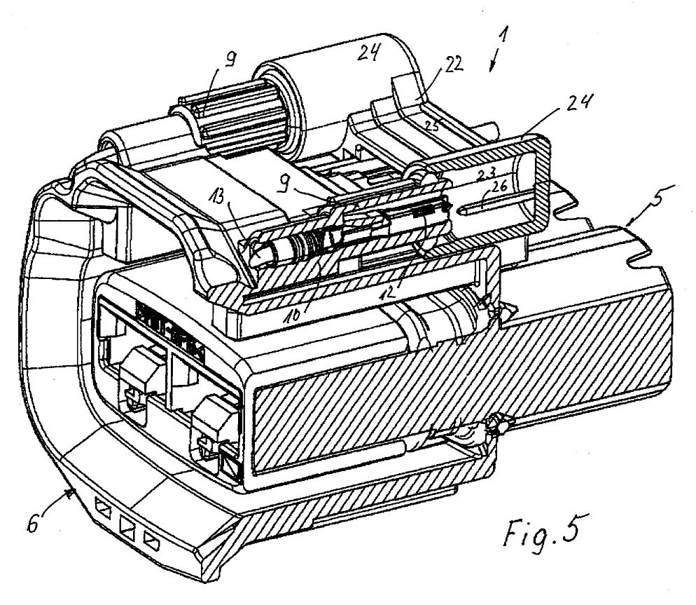

FIG. 5 a further longitudinal sectional view through the first connector, which enables a view onto the arrangement of the second contact elements and the second counter contact elements,

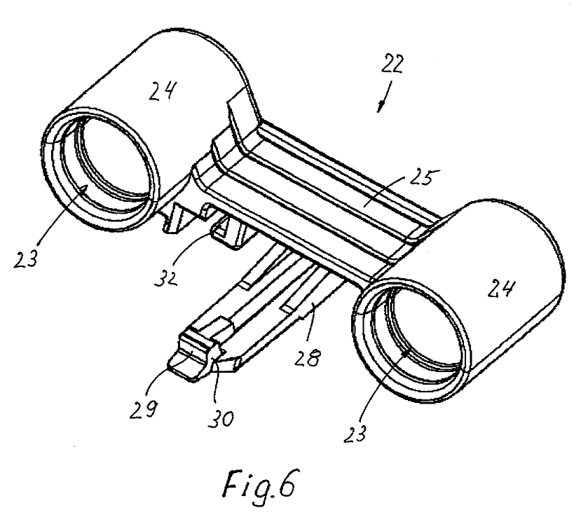

FIG. 6 the slider as a separate part,

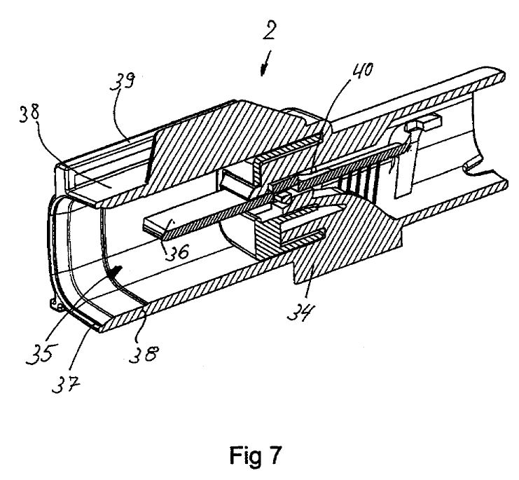

FIG. 7 a longitudinal sectional view through the second connector,

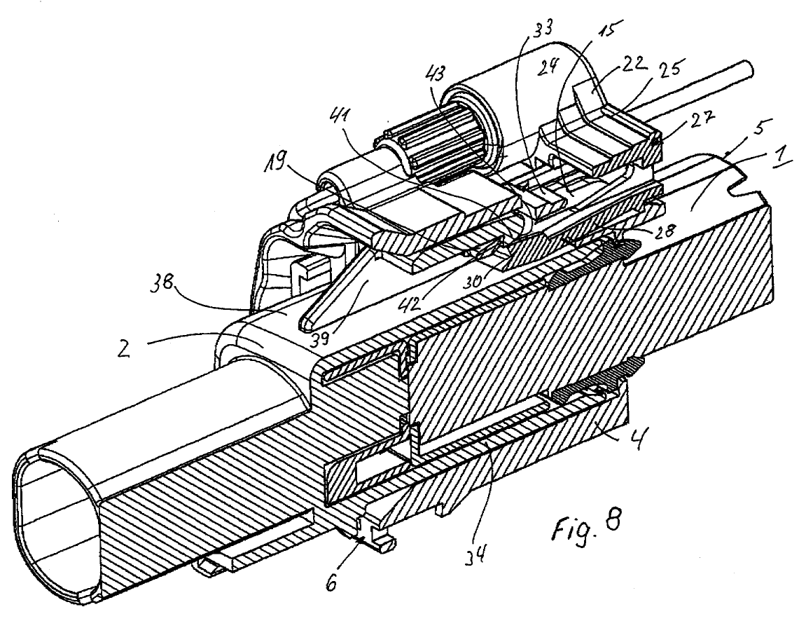

FIG. 8 a connected condition of the two connectors corresponding to FIG. 1, however as a longitudinal sectional view, wherein the slider is still in the first position, but the two connectors are already connected with each other and their locking means are engaged, and

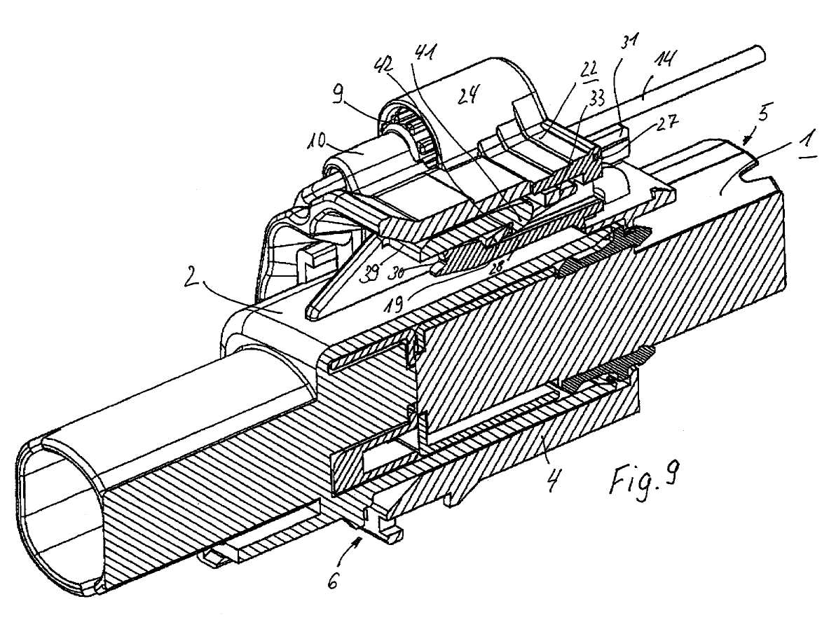

FIG. 9 a longitudinal sectional view corresponding to FIG. 8, wherein, however, the slider is moved into the second position.

FIG. 1 shows the first connector 1 and the second connector 2 centred on the axis 3, however, in the disconnected condition. In this condition the slider 22 is arranged in the first position, in which it is arranged closely to the first end 5 of the first housing 4 of the first connector 1. For connecting, the two connectors 1,2 are moved towards each other along the axis 3. Hereby a portion of the first connector 1, in which first contact elements are arranged, enters a receptacle of the second connector 2, in which the corresponding first counter contact elements are arranged, wherein the first contact elements and the first counter contact elements are electrically conductively connected to each other. Hereby, the two housings, when reaching their final position, are locked with each other. The means, which serve for this, are described in more detail by means of FIGS. 2 to 9.

Firstly, the first connector 1 and its components are described in more detail using FIGS. 2 to 6.

The first connector 1 comprises a first housing 4, which has a first end 5 and a second end 6.

The first housing 6 has an inner housing portion separated from the outer portion and in which the first accommodation chambers 7 are arranged, which are accessible from the second end 6 and in which first contact elements 9 (not shown) are accommodated.

Between the outer portion and the inner portion of the first housing 4 a cavity is arranged.

On the outside of the first housing 4 two lugs 9 are formed, which are formed integrally with the first housing 4 at its connected end 10. These extend parallel to the axis 3. In each lug 9, a second accommodation chamber 11 is provided, which is open towards the first end 5. Connection wires can be inserted towards the second end 6 into the bores, provided in the connected ends 10 and which are connected to the second accommodation chambers 11, namely a first wire 13 and a second wire 14, respectively. These wires 13, 14 belong to a control circuit and are, respectively, at their ends electrically conductively connected to the second contact elements arranged in the second accommodation chambers 11.

As especially visible in FIG. 3, on the first housing 4 a first locking arm 15 is formed, which forms first locking means. This first locking arm 15 has two parallel arm portions 18, which in the direction towards the first end 5 have an end 17 connected to the first housing 4. In the direction towards the second end 6 the first locking arm 15 has a free end 16. At this free end 16 the two arm portions 18 are connected to each other by a cross-bar 19. Therefore, between the two arm portions 18 and the cross-bar 19 a through opening 20 is provided in the first locking arm 15. Furthermore, the first locking arm 15 has an actuation portion 33. In the direction towards the first end 5, the cross-bar 19 has a first locking face 21.

A slider 22, which has two parallel distanced tubular portions 24, which are connected to each other by means of a bridging portion 25, is arranged to the first connector 1. In the two tubular portions 24 receptacles 23 are provided, in which, respectively, a second counter contact elements 26 is accommodated, which is formed to fit to the second contact element 12 in the lugs 9. The two second counter contact elements 26 are connected to each other by means of an electrically conductive connection 27, which extends through the bridging portion 25.

The two tubular portions 24 are guided linearly displaceably on the two projections 9, i.e. concerning the direction between a first position close to the first end 5 and a second position off-set further in the direction towards the second end 6. Direction-wise the slider 22 is displaceable in a limited manner between the first end 5 and the second end 6.

As retaining means a second locking arm 28 is arranged to the slider 22, which locking arm 28 is formed integrally with the bridging portion 25 of the slider 33 and extends centrally between the two tubular portions 24, i.e. starting from the bridging portion 25 in the direction away from the first end 5 towards the second end 6. On the free end distanced from the bridging portion 25, the second locking arm 28 is provided with a projection 30, on which a support face 29 is provided. The support face 29 interacts with the first locking face 21 on the cross-bar 19 of the first locking arm 15. Additionally, the slider 22 is guided on the first guiding means 31 of the first housing 4 by the second guiding means 32 on the slider 22 (see FIG. 6). The second locking arm 28 is arranged between the two arm portions 18 of the first locking arm 15.

In the position shown in FIGS. 2 to 5, the slider 22 is arranged in the position approaching the first end 5, wherein its second locking arm 28 with its support face 29 is supported on the first locking face 21 on the cross-bar 19 of the first locking arm 15 and is, thus, retained in this first position.

In this first position, the second contact elements 12 are still separated from the second counter contact elements 26, which are, respectively, arranged in a receptacle 23, as especially visible from FIG. 5.

In FIG. 6 the slider 22 is visible as a separate component with its two tubular portions 24 and the bridging portion 25, connecting these. The receptacles 23 for the accommodation of the second counter contact elements 26 (see FIG. 3) are visible. Furthermore, it is visible, that the second locking arm 28 extends from the bridging portion 25 and carries at its end the projection 30, on which the support face 29 is arranged. Furthermore, the two second guide means 32, extending approximately parallel to the second locking arm 28, are visible.

The second locking arm 28 is elastically deformable. The first locking arm 15 is elastically deformable as well, so that its free end 16 can approach more or less the outer face of the first housing 4, but always takes up on its own a relaxed position, which, as described in the following, corresponds to an engagement position with the second locking means on the second connector.

The second connector 2 shown in FIG. 7 in a longitudinal sectional view, comprises a second housing 34 with an accommodation chamber 35, in which first counter contact elements 36 are arranged, which are formed to fit to the first contact elements 9 of the first connector 1 and are aligned therewith and are electrically conductively connected to the same, when the first connector 1 is connected to the second connector 2.

The accommodation chamber 35 is enclosed by an envelope portion 38, on which outer face a tunnel portion 39 is arranged, which extends parallel to the axis 3 according to FIG. 1. For connecting the first connector 1 to the second connector 2 the open end 37 of the second connector 2 is facing the second end 6 of the first connector 1.

The tunnel portion 39 is open in the direction of the axis 3. It carries at its roof portion a projection 41, projecting from the envelope portion 38, which forms the second locking means and which has, starting from the open end 37, a contact face 43, which ends in a second locking face 42, extending nearly at a right angle thereto and away from the envelope portion 38. The first counter contact elements 36 are arranged in the third accommodation chambers 40 of the second housing 34.

Connecting the two connectors is described in more detail using FIGS. 8 and 9 in the following. Firstly the two connectors 1, 2 are moved towards each other, wherein a portion of the first connector 1 is inserted into the open end 37 of the second connector 2 and, thus, into its accommodation chamber 35. Due to this the first contact elements 12 and the first counter contact elements 36 are electrically conductively connected to each other. At the same time the first locking arm 15 with its cross-bar 19 approaches the projection 41. During the connecting process the cross-bar 19 moves onto the contact face 43 and the first locking arm 15 is moved in the direction towards the outer face of the envelope portion 38. The first locking arm 15 enters, hereby, the tunnel portion 39. Following the cross-bar 19, also the projection 30 of the second locking arm of the slider 22 gets onto the contact face 43, when further connecting the two connectors 1, 2. Thus, the connection condition shown in FIG. 8 is reached.

As soon as the first locking arm 15 has reached a position, in which the cross-bar 19 has passed the projection 41, the first locking arm 15 can return to its relaxed normal position, whereby first locking face 21 arranged on the cross-bar 19 gets behind the projection 41, so that the first locking face 21 is arranged opposite to the second locking face 42, provided on projection 41. Thus, the two housings 4, 34 are locked with each other. Simultaneously also the second locking arm 28 is deflected due to coming into contact with the contact face 43, so that by means of pushing by hand the slider 22 away from the first end 5 in the direction towards the second end 6, the slider 22 can leave its first position and can be moved into the second position. Hereby, the projection 30 of the second locking arm 28 also passes the projection 41 as well as the cross-bar 19 of the first locking arm 14, arranged directly behind the same, and gets behind the cross-bar 19, whereupon the second locking arm 28 relaxes, i.e. takes up its starting position. Thus, the slider 22 is retained in the second position, in which it approaches the second end 6 by the projection 30 on the cross-bar 19. Thus, the connection condition shown in FIG. 9 is reached. Thus, the actuation portion 33 of the first locking arm 15 is covered by the bridging portion 25 and cannot unintentionally be actuated.

During this movement, the second contact elements 12, which are arranged on the lugs 9, are electrically conductively connected to the second counter contact elements 26, which are connected to each other by means of the electrical connection 27, so that the control circuit is closed by wires 13, 14, initially separated from each other. The closing of this control circuit can be used to activate a control function for example, which enables a current supply to the two electric circuits, closed by connecting the first contact elements 8 with the first counter contact elements 36. For detaching the two connectors 1, 2 initially the slider 22 has to be returned by hand into the first position, in which it is arranged approaching the first end 5. Then, the actuation portion 33 on the first locking arm 15 can be pushed down by hand, by which the cross-bar 19 with the first locking face 21 gets into an area outside the second locking face 42 of projection 41 and the connectors 1, 2 can be pulled away from each other. Thus, initially the control circuit is disconnected, which causes the switching-off of the main circuit, so that the separation of the two connectors 1, 2 can be carried out in a current free condition.

### REFERENCE NUMERALS LIST

1 first connector
2 second connector
3 axis
4 first housing
5 first end
6 second end
7 first accommodation chamber
8 first contact element
9 lug
10 connected end
11 second accommodation chamber
12 second contact element
13 first wire
14 second wire
15 first locking arm/first locking means
16 free end
17 connected end
18 arm portion
19 cross-bar
20 through opening
21 first locking face
22 slider
23 receptacle
24 tubular portion
25 bridging portion
26 second counter contact element
27 electrical connection
28 second locking arm
29 support face
30 projection
31 first guiding means on the first housing
32 second guiding means on the slider
33 actuation portion
34 second housing
35 accommodation chamber
36 first counter contact element
37 open end
38 envelope portion
39 tunnel portion
40 third accommodation chamber
41 projection/second locking means
42 second locking face
43 contact face

1. Connector assembly comprising
a first connector, which
has a first housing with a first end and a second end, wherein the first housing has first accommodation chambers for first contact elements % and two second accommodation chambers each for a second contact element and wherein the first housing has first locking means,
has a slider, which
is linearly displaceable in a limited manner on the first housing (4) in a direction away from the first end towards the second end and reversely between a first position and a second position,
has, respectively, one receptacle for one of the two second counter contact elements, wherein the two second counter contact elements are electrically conductively connected to each other,
a second connector, which
has a second housing with third accommodation chambers arranged correspondingly to the first accommodation chambers for the first counter contact elements fitting to the first contact elements,
has second locking means, which in the connected condition of the first connector with the second connector are engaged with the first locking means, wherein the slider has retaining means, which are supported on the first locking means, as long as the first connector and the second connector are not connected and, thus, the first locking means and the second locking means are not engaged, and retain the slider in the first position and release the same, when the first locking means are engaged with the second locking means, so that the slider is transferable into the second position, in which the second contact elements are connected with the second counter contact elements.

2. Connector assembly according to claim 1, wherein the second locking means are represented by a projection on the second housing which has a second locking face and a contact face.

3. Connector assembly according to claim 1, wherein the first locking means are represented by a first elastically deformable locking arm, which extends in a direction away from the first end towards the second end and which in the direction towards the first end is integrally connected with the first housing and forms in the direction towards the second end a free end, on which the first engagement means are provided, which engage behind the projection on the second housing, representing the second locking means, in the connected condition.

4. Connector assembly according to claim 3, wherein the first locking arm comprises two parallel arm portions, which are connected at the free end by means of a cross-bar, which forms the first engagement means, which comprise a first locking face.

5. Connector assembly according to claim 1, wherein the retaining means are represented by an elastically deformable second locking arm, which is integrally attached on the slider and has a support face, which is part of a projection and by which the second locking arm is supported on the first locking face.

6. Connector assembly according to claim 5, wherein the projection, when moving the slider from the first position into the second position, abuts the abutment face of the projections and, thus, the second locking arm is deflected and that the projection is moved along the projections into a position engaging behind the cross-bar.

7. Connector assembly according to claim 1, wherein the second accommodation chambers of the first housing are arranged in two parallel lugs, which are formed integrally with the first housing and extend from this from a connected end direction-wise towards the first end, and that the receptacles provided on the slider are part of tubular portions, with which they are guided on the lugs.

8. Connector assembly according to claim 1, wherein the first connector serves for connecting to a wire harness and that the second connector is arranged to a device or equipment to be connected and electrically driven.
